(19) United States
(12) Patent Application Publication
(10) Pub. No.: US 2022/0225703 A1
(43) Pub. Date: Jul. 21, 2022

(54) PROTECTIVE HOOD SYSTEM

(71) Applicant: Nina Algee, St Louis, MO (US)

(72) Inventor: Nina Algee, St Louis, MO (US)

(21) Appl. No.: 17/443,050

(22) Filed: Jul. 20, 2021

Related U.S. Application Data
(60) Provisional application No. 63/139,411, filed on Jan. 20, 2021.

(51) Int. Cl. A41D 13/11; A62B 23/02; A41D 13/002

(52) U.S. Cl. CPC A41D 13/1153; A41D 13/0025; A41D 13/1184; A62B 23/02

(57) ABSTRACT

A protective hood system for a user is disclosed. The hood system includes a hood defining a substantially cylindrical shape and is designed to surround a head of the user. The hood system further includes a neck portion disposed at a bottom end of the hood and is designed to contact a neck of the user. An air filter and air source inlet are coupled to the hood. The air source inlet is designed to connect to an air source which supplies air to the hood.

### CROSS-REFERENCE TO RELATED APPLICATION

This application claims the benefit of priority of U.S. provisional application No. 63/139,411, filed Jan. 20, 2021, the contents of which are herein incorporated by reference.

### BACKGROUND OF THE INVENTION

The present invention relates to protective hoods and, more particularly, to a protective hood system that mounts around the neck and covers the entire head of a user to better protect the user from risk contraction and transmitting of infection from an airborne pathogen.

Coronaviruses are widespread viruses that cause a variety of illnesses, ranging from the common cold to, for example, coronavirus disease 2019 (COVID-19). A novel coronavirus, designated SARS-CoV-2 (and what caused COVID-19), has impacted the world since 2019. COVID-19 represents a global public health concern and the World Health Organization has declared it a public health emergency. COVID-19 rapidly increased in spread in a pandemic scale since its first appearance in Wuhan, China.

At present, because of developments in transportation, mutations of viruses and, in general, the way society functions, the world faces continued risks of this and other pandemics, and there is an urgent need for countermeasures. For example, to prevent infection and the spread thereof, when inside an office, store, restaurant or school, or when on public transportation, it is recommended to wear a mask.

However, masks only cover a portion of a user's face—namely, the nose and mouth, and frequently leaves varying size air gaps between the mask and the face of the user. Further, these masks are prone to accidental displacement away from the mouth and/or nose, leaving users exposed to pathogens in their environment. During pandemics, the only time a mask may not be necessary is when an individual is alone or with family, meaning there are many scenarios in which a mask may be necessary, but fails to sufficiently protect the user from risk of infection. Not only, in these scenarios, do masks fail to protect users from infection, but they also fail to prevent users (who may unknowingly have contracted, for example, COVID-19) from spreading infection.

As can be seen, there is a need for a hood that mounts around the neck and covers the entire head of a user to better protect the user from risk of contracting and transmitting infection from an airborne pathogen. There is further a need for a protection system that cannot be accidentally removed once placed around the head.

### SUMMARY OF THE INVENTION

In one aspect of the present invention, a hood system for a user comprises: a hood defining a substantially cylindrical shape and configured to be surround a head of the user; a neck portion disposed at a bottom end of the hood and configured to contact a neck of the user; an air filter coupled to the hood; and an air source inlet coupled to the hood, the air source inlet configured to connect to an air source which supplies air to the hood.

These and other features, aspects and advantages of the present invention will become better understood with reference to the following drawings, description and claims.

### BRIEF DESCRIPTION OF THE DRAWINGS

FIG. 1 is a front perspective view of an embodiment of the present invention;

FIG. 2 is a back perspective view of the embodiment of the present invention;

FIG. 3 is an exploded view of the embodiment of the present invention;

FIG. 4 is a section view of the embodiment of the present invention, taken along line 4-4 of FIG. 1;

FIG. 5 is a top view of the embodiment of the present invention; and

FIG. 6 is a perspective detail view of the embodiment of the present invention, showing a carrying bag with collapsed hood disposed therein.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, one embodiment of the present invention is a protective hood system. The hood system includes a hood defining a substantially cylindrical shape and is designed to surround a head of the user. The hood system further includes a neck portion disposed at a bottom end of the hood and is designed to contact a neck of the user. An air filter and air source inlet are coupled to the hood. The air source inlet is designed to connect to an air source which supplies air to the hood. These, and other aspects of the present invention, are described in greater detail below.

Embodiments of the present invention serve to help contain respiratory droplets that can transmit SARS-CoV-2 from individuals that do not know they have the virus. While the vast majority of masks are configured to secure to the front portion of a user's head and face front, embodiments of the present invention sit comfortably around the entire head without shifting, effectively creating a protective bubble around the user against germs and other infectious diseases, while permitting up to a 340-degree viewing angle for the user. These embodiments cannot be accidentally removed once mounted around the head. This design is especially advantageous in places of large public gatherings, such as school or sporting events, because “social distancing” is no longer necessary to stay safe. Further, while not described in greater detail herein, further embodiments of the present invention may be used with pets.

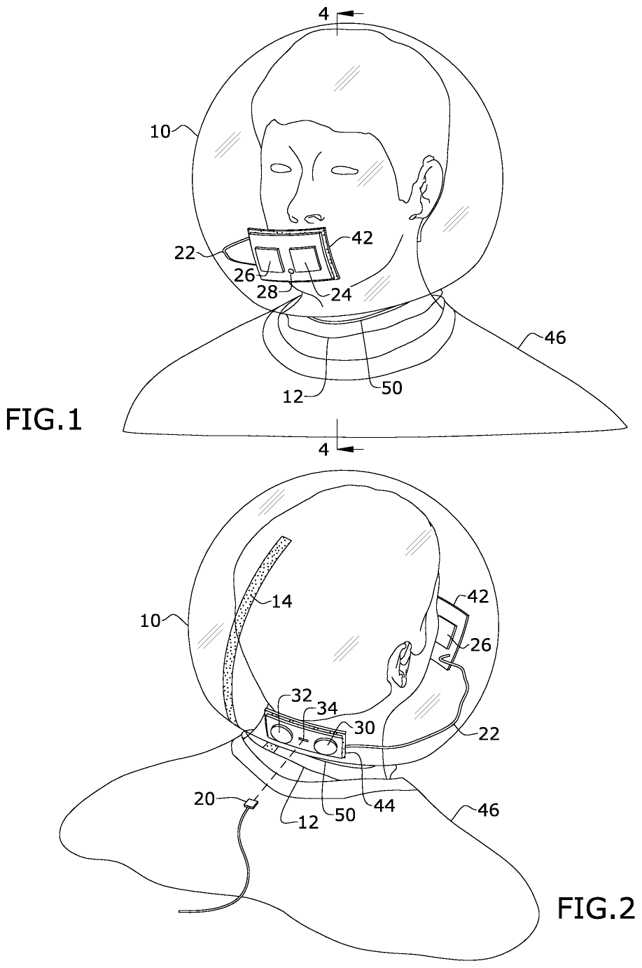

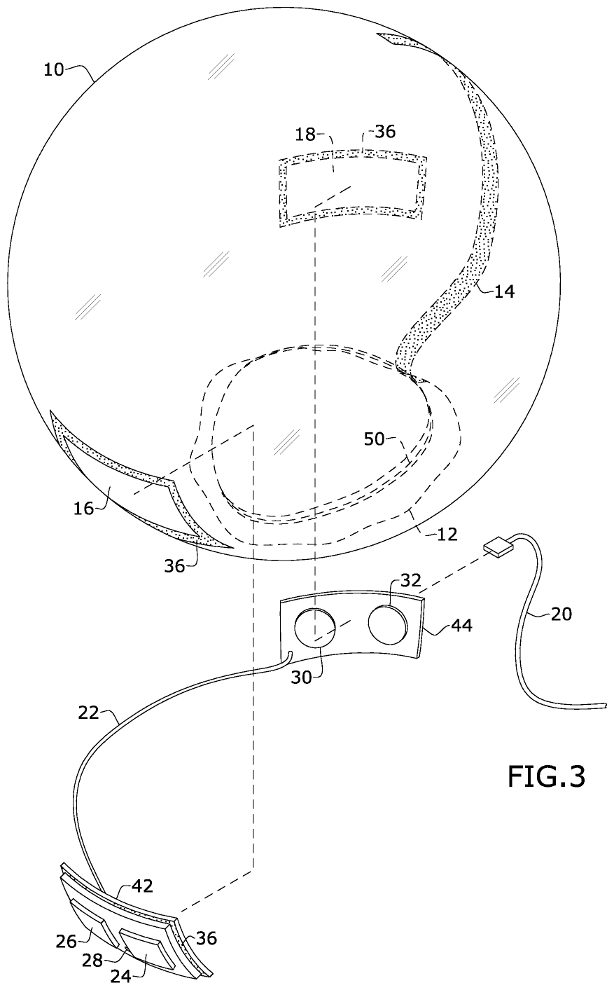

Referring to FIGS. 1-6, a protective hood system includes a clear hood 10 which, in certain embodiments, may be formed from a thick, durable, transparent plastic. The hood 10, in use, creates and maintains a bubble/spherical shape due to positive air pressure, as described in greater detail below. Because the hood 10 is clear, a user 46 is permitted the viewing angles he/she would otherwise have without the hood 10 on. Further, the spherical shape of the hood 10 means that it is not actually in contact with the user 46 while he/she is wearing it, as opposed to face masks which are quite frequently snug on the face and uncomfortable to wear. Consequently, individuals who wear various cosmetics, such as lip gloss and makeup, need not worry about the cosmetics getting smudged/ruined by a mask. A user 46 could even comfortably wear glasses, which are difficult to wear simultaneously with a conventional face mask. The mask 10, of course, may be provided in various sizes to accommodate varying head sizes of individuals. Along a rear side of the hood 10 is a fastener 14, such as complementary hook and loop fasteners or a zipper, for putting on and taking off the hood 10. As shown in FIG. 3, a front opening 16 is defined on a front side of the hood 10, with a rear opening 18 being defined on the rear side of the hood 10.

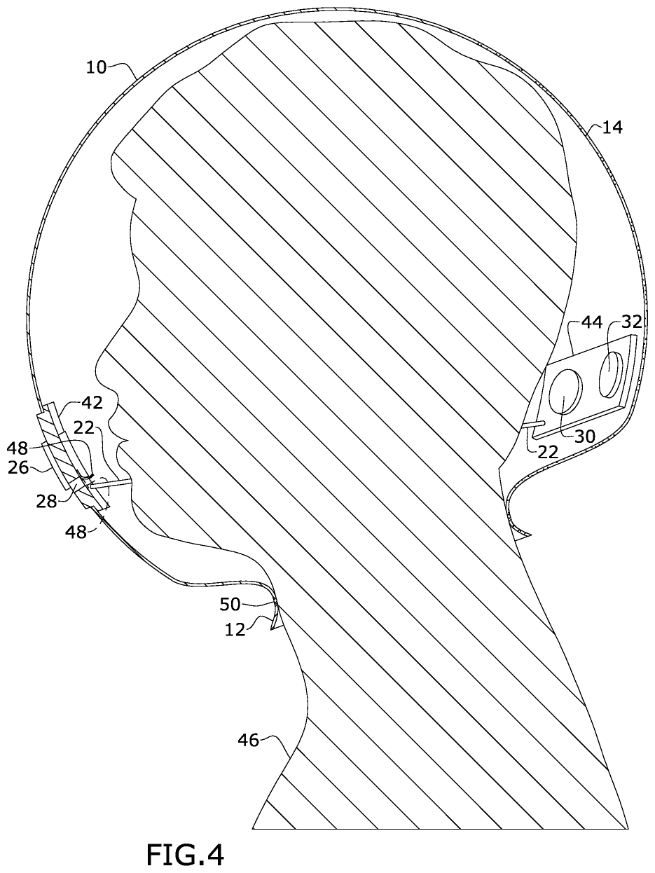

As shown in FIG. 4, the hood 10, at a bottom end thereof, is coupled to or otherwise integral with a neck portion 12 which, in use, extends sealingly around the neck of the user 46 to form a closed/isolated environment for the head of the user 46. This seal may be achieved, for example, using an elastic neck band 50 which extends around a circumference of the bottom end of the hood 10. In certain embodiments, the band 50 may be provided separately from the hood 10 and, after the hood has been positioned to cover the user's head, is pulled over the hood and down to the neck region of the user 46. The reverse procedure would then be followed when removing the hood 10. In other embodiments, the band 50 may be permanently coupled with the neck portion 12.

As shown, for example, in FIG. 3, an air filter 24 (such as an N-95 filter) and a speaker/microphone set 26 are mounted on a front housing 42 that is detachably couplable to the hood 10 in the front opening 16 via hook and loop fasteners 36. The air filter 24 allows the user to safely inhale and exhale without pathogens being transmitted in either direction through the hood. In certain embodiments, the filter may be a type of respirator which removes particles from the air that are breathed through it. These respirators filter out at least 95% of very small (0.3 micron) particles. N-95 filtering facepiece respirators (FFRs) can filter out all types of particles, including bacteria and viruses. The speaker/microphone set 26 allow the user 46 to clearly speak out of the hood 10. The speaker/microphone set 26 may be provided with a short-range wireless receiver (such as a BLUETOOTH™ receiver) so that a phone of the user 46 can be paired with the set 36 for playing music and taking phone calls. Additionally, in certain embodiments, a straw opening 28 may be provided in the front housing that is selectively openable using various appropriate means, such as a flap or in a manner that it automatically closes while not in use (i.e., the user 46 is not drinking a beverage).

An air supply inlet 30 and air conditioning and/or heater 32 are mounted on a rear housing 44 that is detachably coupled to the hood 10 in the rear opening 18 via hook and loop fasteners 36. In certain embodiments, the air supply inlet 30 may couple with a supply line that feeds sterile compressed air to the hood, which creates the aforementioned positive pressure and ensuring the user 46 receives pathogen free breathing air. In certain embodiments, the air conditioning and/or heater 32 are embodied as either heating elements or a port for cold compressed air (effectively creating a cooling effect in the hood 10). It will be appreciated that other heating and cooling systems may be integrated in accordance with the present invention.

The rear housing 44 further includes a port 34 for receiving charging cord 20 (such as a USB charging cord), which charges one or more batteries (not shown) that power the various electrical components of the hood system (e.g., the speaker/microphone set 26 and the air conditioning and/or heater 32. In other embodiments, the hood system may include replaceable batteries rather than rechargeable ones. The front housing 42 and the rear housing 44 may be electrically via, for example, a wire 22. Appropriate switches/controls for selectively operating the various components of the hood system are also provided.

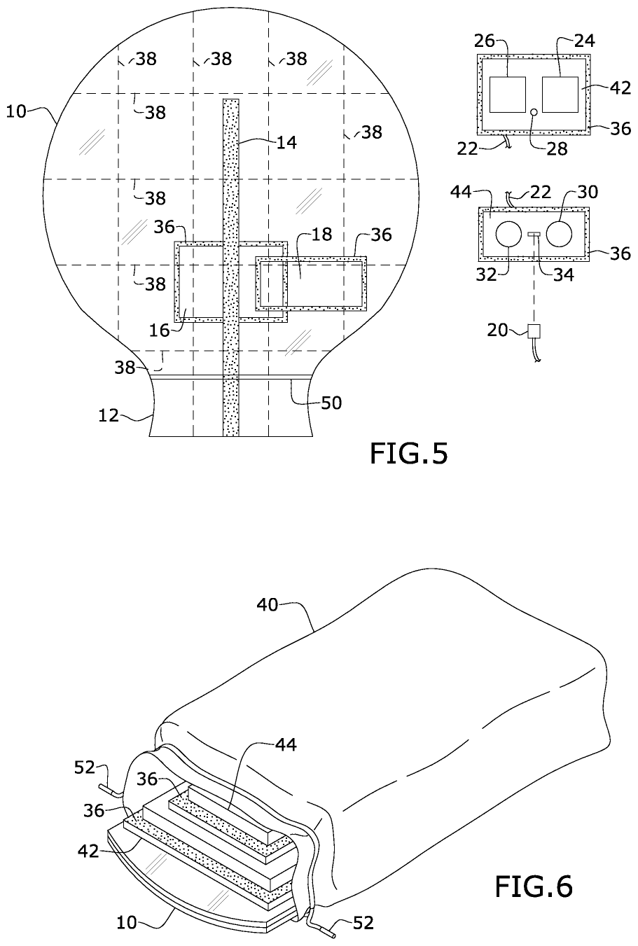

Advantageously, the hood system may be easily folded up for storage. FIG. 5 illustrates the hood system in a state just prior to being folded up and inserted in a storage bag 40. Reference number 38 corresponds to exemplary folding lines 38, such as pre-formed creases, to collapse the hood 10 more easily. As further shown in FIG. 5, the front housing 42 and rear housing 44 are first detached from the hood, and then the hood 10 is then folded up. Once it has been folded up/collapsed, the hood 10 and the front housing 42 and the rear housing 44 may be inserted into the storage bag 40. The storage bag 40 may include a drawstring to secure it shut.

To make an embodiment of the present invention, the various components would simply need to be manufactured using any appropriate process and assembled as illustrated and described herein. To use, the hood system is first pulled out of the storage bag 40. Next, the hood 10 is unfolded, the fastener 14 is opened up, the hood 10 is slipped over a head of the user 46, and the fastener 14 is closed. The air supply inlet 30, via supplied air from an air source, feeds air to the bubble created by the hood 10. The elastic neck band 50 is placed over the neck portion 12 to create a completely sealed/isolated environment. The speaker/microphone set 26 may be used when talking, and the air conditioning and/or heater 32 may be used if temperature regulation is required within the hood 10.

Embodiments of the present invention are capable of being worn by anyone in a crowded environment and can even be worn for hours by healthcare professionals. The unique design is comfortable to wear for long periods and is reusable as long as the hood 10 does not get any holes/punctures in it. It should be understood, of course, that the foregoing relates to exemplary embodiments of the invention and that modifications may be made without departing from the spirit and scope of the invention as set forth in the following claims.

It should also be noted that while terms like “front” and “rear” are used in the specification, it would be appreciated by those with skill in the art that various components described as being in the “front” may be repositioned, as appropriate, with the same being true for components described as being in the “rear”. In the following claims, any labelling of elements, limitations, steps, or other parts of a claim (for example, first, second, etc., (a), (b), (c), etc., or (i), (ii), (iii), etc.) is only for purposes of clarity, and are not to be interpreted as suggesting any sort of ordering or precedence of the claim parts so labelled. If any such ordering or precedence is intended, it will be explicitly recited in the claim or, in some instances, it will be implicit or inherent based on the specific content of the claim. To further aid the USPTO and any readers of any patent issued on this application, it is additionally noted that there is no intent any of the appended claims to invoke paragraph (f) of 35 U.S.C. § 112 as it exists on the date of filing hereof unless the words “means for” or “step for” are explicitly used in the particular claim.

What is claimed is:

1. A hood system for a user, the hood system comprising:
a hood defining a substantially cylindrical shape and configured to be surround a head of the user;
a neck portion disposed at a bottom end of the hood and configured to contact a neck of the user;
an air filter coupled to the hood; and
an air source inlet coupled to the hood, the air source inlet configured to connect to an air source which supplies air to the hood.

2. The hood system of claim 1, wherein the air filter is directly coupled to a first housing that is detachably coupled to the hood to selectively cover a first opening in the hood.

3. The hood system of claim 2, further comprising a speaker and microphone set that are mounted on the first housing.

4. The hood system of claim 1, wherein the air source inlet is defined in a second housing that is detachably coupled to the hood to selectively cover a second opening in the hood.

5. The hood system of claim 4, further comprising a heater, an air conditioner, or a heater and an air conditioner coupled to the second housing.

6. The hood system of claim 1, wherein the hood comprises a substantially transparent material.

7. The hood system of claim 1, further comprising an elastic band configured to compress the neck portion against the neck of the user.

8. The hood system of claim 1, further comprising a storage bag for receiving the hood, with the hood being foldable to be inserted in the bag.

9. The hood system of claim 1, further comprising a first housing and a second housing, with the hood defining a first opening for receiving the first housing and a second opening for receiving the second housing,

10. The hood system of claim 1, further comprising a storage bag for receiving the hood, the first housing and the second housing, with the hood being foldable to be inserted in the bag.
